(19) United States
(12) Patent Application Publication
(10) Pub. No.: US 2014/0100975 A1
(43) Pub. Date: Apr. 10, 2014

(54) Payment System and Method

(71) Applicant: TOUCH NETWORKS PTY LTD, Melbourne (AU)

(72) Inventor: Jason Andrew Van, East Killara (AU)

(73) Assignee: Touch Networks Pty Ltd, Melbourne (AU)

(21) Appl. No.: 13/645,693

(22) Filed: Oct. 5, 2012

(51) Int. Cl. G06Q 20/36; G06Q 20/20; G06Q 20/40

(52) U.S. Cl. 705/21; 705/41

(57) ABSTRACT

A payment system, including: a host server; a digital wallet for storing credit of a user; a user mobile communications device for data communication with the host server; and a point-of-sale terminal operable by a vendor. The point-of-sale terminal is configured to receive purchase data indicative of a desired purchase by the user and to transmit the purchase data to the host server, the purchase data including price data, the mobile communications device is configured to receive the purchase data from the host server or from the point-of-sale terminal and to prompt the user to input user authorization, the mobile communications device is configured to receive the user authorization and in response thereto to transmit authorization data to the host server, and the host server is configured to respond to receiving the authorization data by initiating transfer of funds according to the price data from the digital wallet to a vendor account.

### FIELD OF THE INVENTION

The present invention relates to a payment system and method, of particular but by no means exclusive application as a mobile payment system permitting payments to be made from a mobile telecommunications device such as a mobile telephone, tablet computer or the like.

### BACKGROUND OF THE INVENTION

US 2012/166333 discloses a digital wallet that facilitates purchases using a mobile electronic device and stores information associated with transactions, such as purchase confirmations and receipts. The digital wallet stores information for use in transactions, pertaining to financial accounts, users and shipping. The digital wallet interacts with a merchant's website during a purchase to obtain information regarding the purchase, and provides a user interface for the user to review and confirm the purchase information. The user interface also allows the user to select a payment option and specify shipping information, etc. The digital wallet transmits user confirmation to the merchant's website and receive a receipt for the purchase, and stores the receipt.

### SUMMARY OF THE INVENTION

In a first broad aspect, the present invention provides a payment system, comprising:
a host server;
a digital wallet for storing credit of a user;
a user mobile communications device for data communication with the host server; and
a point-of-sale terminal operable by a vendor;
wherein the point-of-sale terminal is configured to receive purchase data indicative of a desired purchase by the user and to transmit the purchase data to the host server, the purchase data including price data, the mobile communications device is configured to receive the purchase data from the host server or from the point-of-sale terminal and to prompt the user to input user authorization, the mobile communications device is configured to receive the user authorization and in response thereto to transmit authorization data to the host server, and the host server is configured to respond to receiving the authorization data by initiating transfer of funds according to the price data from the digital wallet to a vendor account.

In one embodiment, the host server includes a database of vendors and respective vendor locations. The mobile communications device may be configured to search the database of vendors and respective vendor locations.

In another embodiment, the host server includes a user address database containing an address of the user.

In a particular embodiment, the host server includes a user address database containing an address of the user, the host server is configured to search the database of vendors and respective vendor locations for all vendors within a predefined distance of the address of the user, and to download to the mobile communications device identification data indicative of the vendors within the predefined distance of the address of the user, and wherein the mobile communications device is configured to store the identification data thus downloaded in a searchable memory of the mobile communications device.

The predefined distance may be between 10 and 30 km, though is typically between 15 and 25 km and in particular embodiment is approximately 20 km.

In a second broad aspect, the present invention provides a payment method, comprising:
a point-of-sale terminal receiving purchase data indicative of a desired purchase by a user, the purchase data including price data;
the point-of-sale terminal transmitting the purchase data to a host server;
a user mobile communications device receiving the purchase data from the host server or from the point-of-sale terminal;
the mobile communications device prompting the user to input user authorization;
the mobile communications device receiving the user authorization and in response thereto transmitting authorization data to the host server; and
the host server responding to receiving the authorization data by initiating transfer of funds according to the price data from a digital wallet of the user to a vendor account.

In a third broad aspect, the present invention provides computer software executable on a computing system that, when executed, implements the payment method described above.

It should be noted that any of the various features of each of the above aspects of the invention can be combined as suitable and desired.

### BRIEF DESCRIPTION OF THE DRAWING

In order that the invention may be more clearly ascertained, embodiments will now be described, by way of example, with reference to the accompanying drawing, in which:

FIG. 1 is a schematic view of a payment system according to an embodiment of the present invention;

FIG. 2 is a schematic view of a mobile telephone of the payment system of FIG. 1;

FIG. 3 is a flow diagram of a purchase conducted with the payment system of FIG. 1;

FIG. 4 is a view of the display of the mobile telephone of FIG. 2 during an exemplary transaction conducted with the payment system of FIG. 1;

FIG. 5 is a view of the display of the mobile telephone of FIG. 2 during an exemplary transaction;

FIG. 6 is a view of the display of the mobile telephone of FIG. 2 during an exemplary transaction;

FIG. 7 is a view of the display of the mobile telephone of FIG. 2 during an exemplary transaction;

FIG. 8 is a view of the display of the mobile telephone of FIG. 2 during an exemplary transaction;

FIG. 9 is a view of the display of the mobile telephone of FIG. 2 during an exemplary transaction;

FIG. 10 is a view of the display of the mobile telephone of FIG. 2 during an exemplary transaction;

FIG. 11 is a view of the display of the mobile telephone of FIG. 2 during an exemplary transaction;

FIG. 12 is a view of the display of the mobile telephone of FIG. 2 during an exemplary transaction;

FIG. 13 is a view of the display of the mobile telephone of FIG. 2 during an exemplary transaction;

FIG. 14 is a view of the display of the mobile telephone of FIG. 2 during an exemplary transaction;

FIG. 15 is a view of the display of the mobile telephone of FIG. 2 during an exemplary transaction;

FIG. 16 is a view of the display of the mobile telephone of FIG. 2 during an exemplary transaction;

FIG. 17 is a view of the display of the mobile telephone of FIG. 2 during an exemplary transaction;

FIG. 18 is a view of the display of the mobile telephone of FIG. 2 during an exemplary transaction;

FIG. 19 is a view of the display of the mobile telephone of FIG. 2 during an exemplary transaction;

FIG. 20 is a view of the display of the mobile telephone of FIG. 2 during an exemplary transaction;

FIG. 21 is a view of the display of the mobile telephone of FIG. 2 during an exemplary transaction;

FIG. 22 is a view of the display of the mobile telephone of FIG. 2 during an exemplary transaction;

FIG. 23 is a view of the display of the mobile telephone of FIG. 2 during an exemplary transaction;

FIG. 24 is a view of the display of the mobile telephone of FIG. 2 during an exemplary transaction;

FIG. 25 is a view of the display of the mobile telephone of FIG. 2 during an exemplary transaction;

FIGS. 26a to 26d are views of the display of the mobile telephone of FIG. 2 during an exemplary transaction;

FIGS. 27a to 27c are views of the display of the mobile telephone of FIG. 2 during an exemplary transaction;

FIG. 28 is a view of the display of the mobile telephone of FIG. 2 during an exemplary transaction;

FIGS. 29a to 29c are views of the display of the mobile telephone of FIG. 2 during an exemplary transaction;

FIGS. 30a to 30d are views of the display of the mobile telephone of FIG. 2 during an exemplary transaction;

FIGS. 31a to 31c are views of the display of the mobile telephone of FIG. 2 during an exemplary transaction;

FIG. 32 is a view of the display of the mobile telephone of FIG. 2 during an exemplary transaction;

FIGS. 33a and 33b are views of the display of the mobile telephone of FIG. 2 during an exemplary transaction;

FIGS. 34a to 34d are views of the display of the mobile telephone of FIG. 2 during an exemplary transaction;

FIGS. 35a to 35c are views of the display of the mobile telephone of FIG. 2 during an exemplary transaction;

FIGS. 36a to 36c are views of the display of the mobile telephone of FIG. 2 during an exemplary transaction; and

FIGS. 37a to 37c are views of the display of the mobile telephone of FIG. 2 during an exemplary transaction.

### DETAILED DESCRIPTION

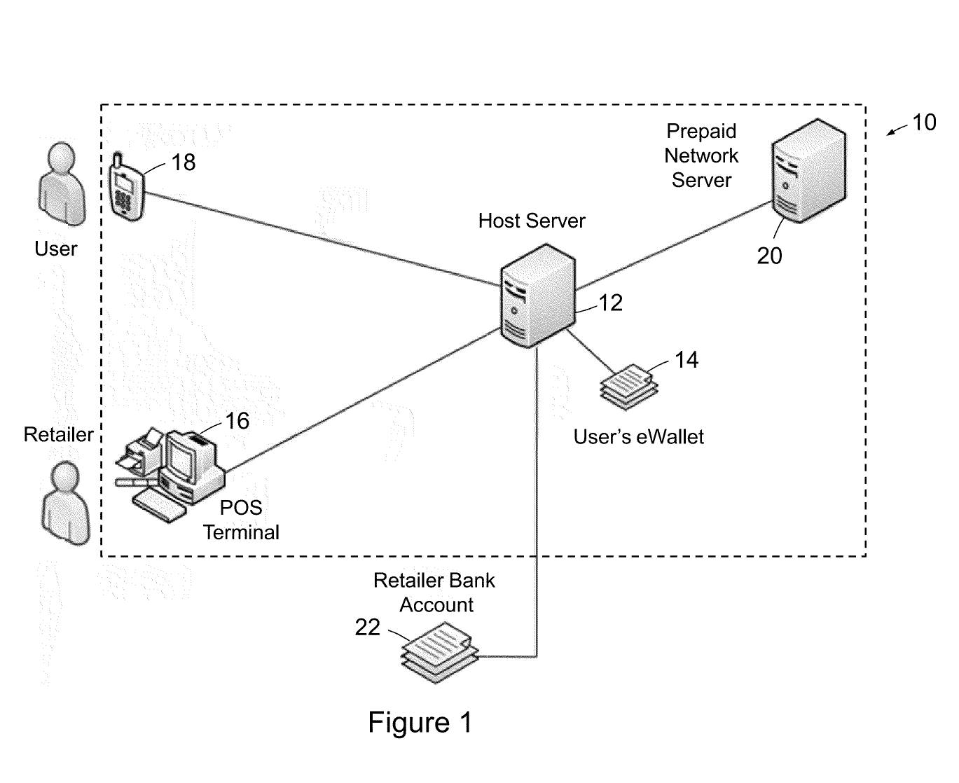

According to an embodiment of the present invention, there is provided a payment system 10 as depicted schematically at 10 in FIG. 1.

System 10 includes a system host server 12, a user digital wallet in the form of eWallet 14, a retailer point-of-sale (POS) terminal 16, a user handset in the form of a mobile telephone 18 (which has an inbuilt camera), and a prepaid network server 20 of a vendor, in this example a telecommunications service provider that provides a telecommunications network on a pre-paid basis. It should be noted, however, that prepaid network server 20 could be that of any vendor that conducts business on a pre-paid basis and hence holds or controls user credit for active users.

The user, in order to use system 10, has an account with the telecommunications service provider, and eWallet 14—in broad terms—embodies that account and contains the user's funds in the form of electronic credit or tender, the balance of which can be ascertained and modified under the control of host server 12. In principle, therefore, the balance of the user's account is the same as the balance of eWallet 14; however, when accessing the account on-line, the user may be presented by prepaid network server 20 with two balances, a first being the amount that the user has in eWallet 14 for spending generally and a second being the balance in call credit that is available for use on mobile telephone 18 as part of the telecommunications service provider mobile telephony credit process. The second balance could be expressed in real currency or an exaggerated currency. For example, some mobile telephony plans may give the user a real dollar balance but others a credit balance based on how much the user has paid (such as “$40 per month” for “Unlimited calls for the month”). Nonetheless, the terms “digital wallet” and “eWallet” can be regarded as synonymous with “account” in most if not all embodiments.

Thus, the user's eWallet 14—which is in the form of electronic data stored in a suitably secure location—comprises data indicative of the credit held by the user for use on the prepaid network of the telecommunications service provider and for general use according to the present embodiment; that credit may be expressed in any suitable form, whether dollars, minutes, bytes, arbitrary points or otherwise. User eWallet 14 may be resident on host server 12 or elsewhere, including for example in a partition (if one is available) in prepaid network server 20. From one perspective, therefore, the funds are held in eWallet 14, but in reality the funds in eWallet 14 may merely mirror ‘actual’ funds held in a trust account provided by a bank and reconciled with eWallet 14 by the telecommunications service provider on an essentially instantaneous basis. The telecommunications service provider in such cases would reconcile the total trade of funds on a daily basis.

In short, system 10 allows a user of the prepaid network to use funds stored in his or her eWallet to purchase goods and services at (participating) retailers, including with the prepaid network, with the host server 12 attending to the processing of balances (of eWallets, etc) and data reconciliation. However, the user's funds (in eWallet 14) are controlled by the telecommunications service provider until used by the user.

The retailer's bank account 22, which cooperates with system 10 (as is described below), is also depicted in the figure but does not form a part of system 10.

Communications between the various components of system 10 is over any suitable telecommunications network or networks. For example, between mobile telephone 18 and host server 12, and between POS terminal 16 and host server 12, communication is provided by the telecommunications service provider's wireless network and the internet.

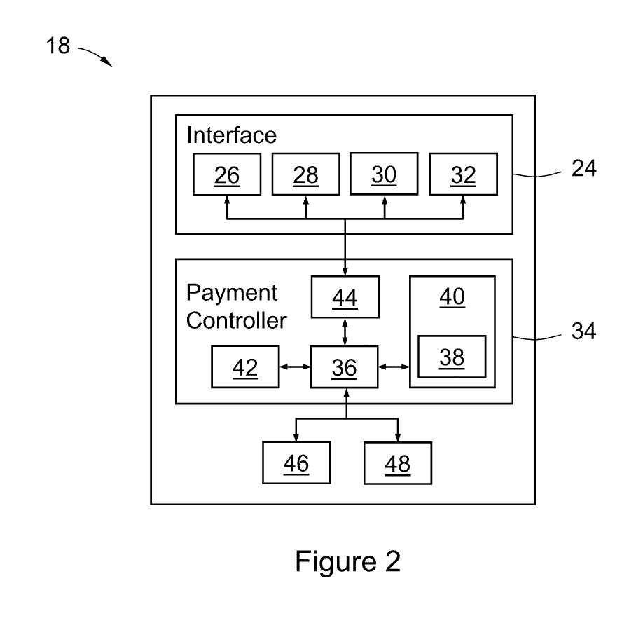

FIG. 2 is a schematic view of mobile telephone 18. Mobile telephone 18 has a user interface 24 arranged to enable manual interaction between a user and system 10 and for this purpose includes the typical input/output components of a mobile telephone, for entering instructions (including telephone numbers), selecting applications, etc. Components of the interface may vary from embodiment to embodiment but will typically include a keypad 26 to enable a player to input instructions, search terms, telephone numbers, etc, a display 28 (comprising a screen that, in this embodiment, is a touch-screen and hence both an input and output device), a speaker 30 and a headphone/earpiece jack 32.

Mobile telephone 18 also has a payment controller 34 in data communication with interface 24 and including a processor 36 that processes payment instructions in accordance with the payment method of the present embodiment, and outputs payment outcomes to display 28. The payment instructions are stored as an user-operable application 38 comprising program code in a memory 40 but can also be hardwired. Herein the term “processor” is used to refer generically to any device that can process payment instructions in accordance with the payment method of the present embodiment and may comprise a microprocessor, microcontroller, programmable logic device or other computational device. Payment controller 34 also includes an operating system 42 (in the form of, for example, the Android (trade mark) operating system) and a graphical windowing server 44, which receives input from interface 24 and displays to display 28.

Mobile telephone 18 is also provided, as will be understood by those in the art, with hardware and software for determining the location of mobile telephone 18; this determination can be based, for example, on the mobile telephone cell or cells closest to the mobile telephone 18 (where proximity is determined based on signal strength). In this embodiment, however, mobile telephone 18 has a GPS receiver 46 so that mobile telephone 18 can determine its location by known GPS techniques and provide coordinates indicative of its location to payment controller 34.

Briefly, a user with funds 48 loaded on his or her mobile telephone 18 can operate the application on mobile telephone 18 when visiting a retailer to purchase goods or services. In order to the complete the transaction, the retailer asks the user to select the payment method for the goods and/or services to be purchased. The user elects to use system 10 and, to do so, selects application 38 on mobile telephone 18, using interface 24—in this embodiment by tapping an icon that corresponds to application 38 and is displayed on display 28. Application 38 determines the location of mobile telephone 18, and by implication of the user and retailer, by requesting GPS coordinates from GPS receiver 46; system 10 uses the GPS coordinates, once received, to determine the most likely retailer or retailers. This is done by application 38 by comparing the GPS coordinates with a table of retailer locations stored in memory 40 on mobile telephone 18 (as discussed in greater detail below) or, if that comparison fails to locate the correct retailer, by sending the GPS coordinates to host server 12 to compare with a table of retailer locations stored on host server 12 and to return the most likely retailer or retailers to mobile telephone 18. The resulting list of one or more most likely retailers—whether generated by application 38 or host server 12—is displayed by application 38 on display 38, and the user responds by selecting the correct retailer, firstly by selecting the retailer group to which the retailer belongs and subsequently the specific name and address of the most likely candidate. The user then employs interface 24 to enter the amount to be paid to the retailer into mobile telephone 18. The retailer POS terminal 16 receives a notification from the host server 12 that the payment has been made; this notification is similar to the notification that a credit transaction has been accepted by a bank. The transaction is then complete.

System 10 thus allows the user to make a payment quickly; typically this takes no longer than the time requires to perform a comparable credit card transaction. Application 38 is configured to learn from the user's interactions with retailers and subsequently to present to the user the most appropriate or likely retailer information (where that information cannot be gained from the network quickly due to poor coverage), based on the location and nature of each of the user's past purchases. For example, if the user has most frequently or most recently purchased mobile telephone credit from a specific retailer at a particular location, on a subsequent occasion when an identical or comparable purchase is attempted, but network coverage is poor or non-existent, application 38 compares the intended purchase with such past purchases, determines one or more likely retailers therefrom, and displays the list of one or more most likely retailers on display 38 so that the user can select the correct retailer.

Some of the advantageous features of system 10, as are detailed below, are:
Payment completion as the first option on entry to the application
Storage of retailer's particulars directly within memory 40 to save network traffic and reduce the transaction processing timeframe
Input of terminal number where there are multiple POS terminals in place in a retailer outlet.
Locating stores within 20 km radius of home location as a first priority
Scanning of QR (Quick Response) codes to determine the retailer's location when GPS or other methods fail.
Scanning of a user's personal QR code to activate a transaction—where the POS application and its hardware can accept such a code.
Easy to use navigation—replicable across, for example, iPhone, Android and Blackberry devices.
PCI-DSS Level 1 payment compliance.

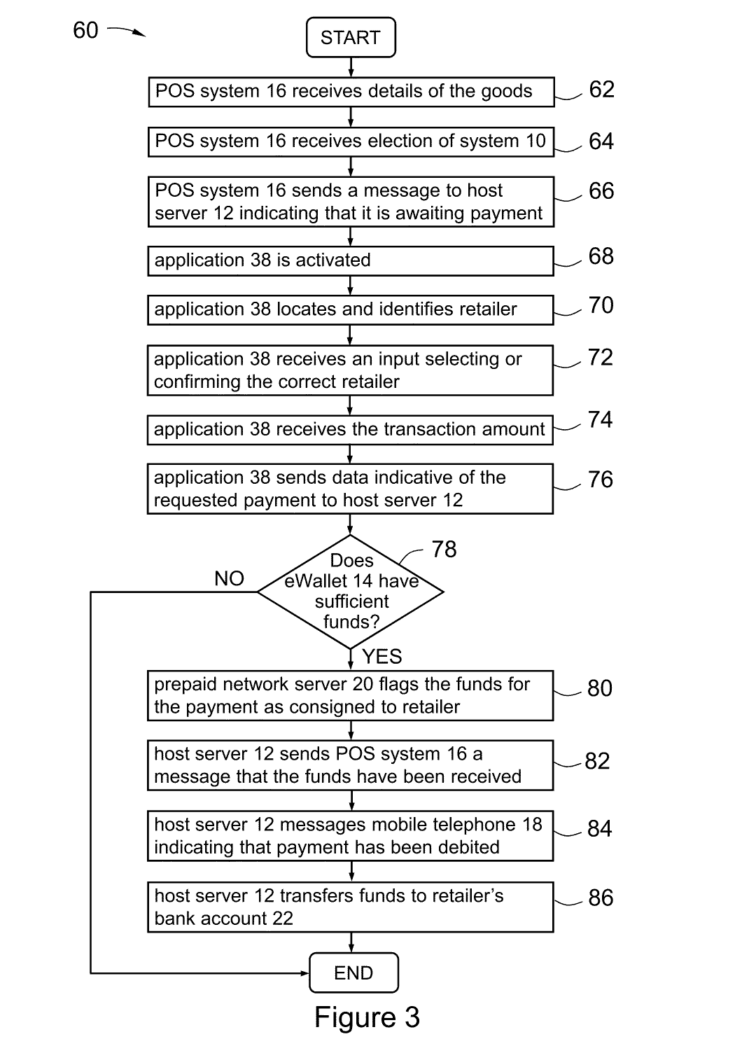

FIG. 3 is a flow diagram 60 of the method implemented by system 10, as used in the example of the purchase of $80 worth of goods from a convenience store that accepts payment with system 10. Referring to FIG. 3, at step 62 POS terminal 16 receives details of the goods, those details having been inputted by the retailer (such as by scanning barcodes on the goods). At step 64, POS terminal 16 receives the election of system 10 as the desired means of payment for the goods, that selection having been made in this example by the retailer. At step 66, POS terminal 16 sends a message to host server 12 indicating that it is awaiting payment in an $80 transaction. At step 68, application 38 on the user's mobile telephone 18 is activated by the user and, at step 70, application 38 uses GPS receiver 46 to ascertain location and identify the retailer (with the assistance of host server 12, as described above). At step 72, application 38 receives an input selecting or confirming the correct retailer (by user selection) and, at step 74, the transaction amount (viz. $80) (by user operation of keypad 26). At step 76, application 38 responds by sending data indicative of the requested payment to host server 12. At step 78, host server 12 checks whether the user's eWallet 14 has sufficient available funds. In this example, eWallet 14 is held within host server 12 although, as discussed above, it may be held in any convenient and secure location, such as on prepaid network server 20.

If, at step 78, sufficient funds were not available, the transaction is declined and processing ends. If, however, at step 78 sufficient funds are found to be available, processing continues at step 80 where prepaid network server 20 flags the funds for the payment (in this example, $80) as being consigned to the retailer.

At step 82, host server 12 sends the retailer's POS terminal 16 a message stating or indicating that the funds have been received by prepaid network server 20 on the retailer's behalf (or allocated to the retailer by prepaid network server 20), so that the retailer knows that the goods can therefore be released to the user. At step 84, host server 12 sends a message (such as by email, SMS or otherwise, though in this embodiment by SMS) to the user's mobile telephone 18 indicating that the payment (in this example, $80) has been debited from the user's eWallet 14.

The transaction having been completed, the retailer releases the goods to the user.

At step 86, host server 12 transfers the funds (in this example, $80) to the retailer's bank account 22, using exiting protocols for doing so. This can be done overnight or immediately, depending upon the relevant transaction rules (which may be imposed by law and/or contract). processing then ends.

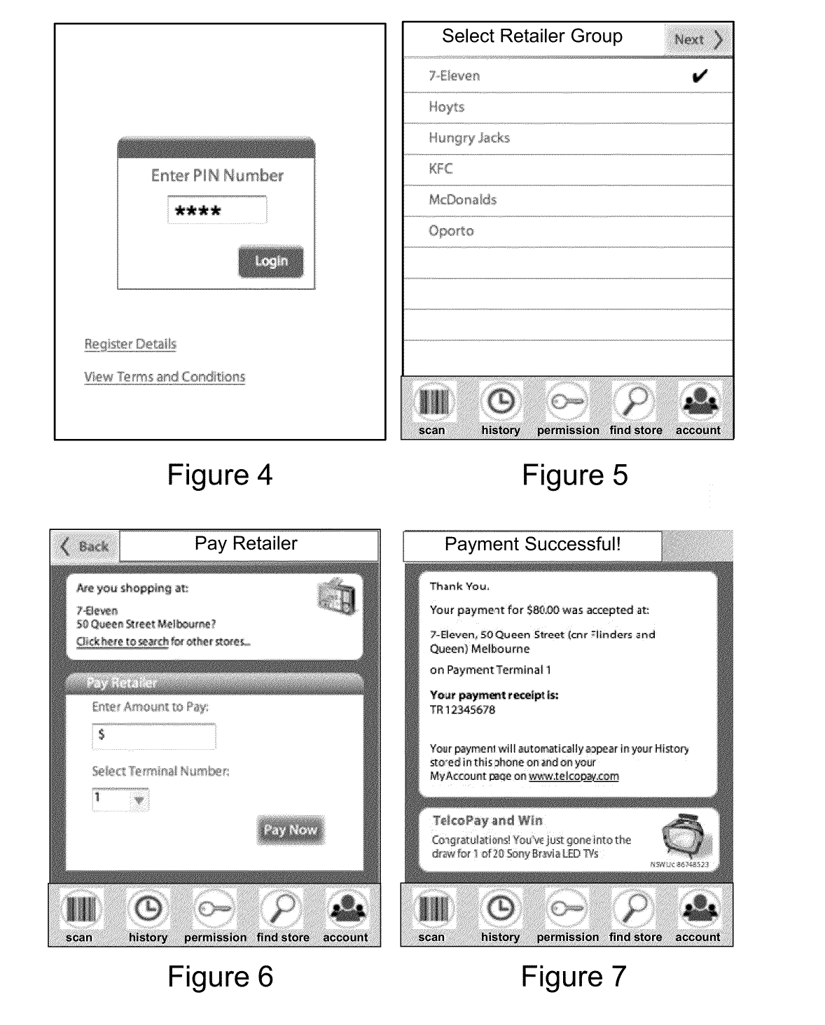

FIGS. 4 to 37c are views of display 28 during exemplary transactions, such as making a purchase, checking the history of purchases and payments, and updating user details.

FIG. 4 is a view of the Home Screen, displayed when application 38 is started: the Home Screen prompts the user to enter a password in the form of a four digit PIN in order to enter and use application 38. The PIN number is entered and saved in a “Register Details” procedure upon the first use of application 38 by the user. The PIN can be changed at a later time by the user by operation of application 38.

Failure to enter the correct PIN within five attempts will disable application 38, providing a level of protection if the phone is stolen or lost. In the event that the user forgets the PIN, application 38 can be uninstalled and re-installed. However, for security purposes, previous information is made unavailable to the user from a re-installed version of application 38.

FIG. 5 is a view of the screen with which the user selects the retailer group. GPS systems are generally only capable of providing location in the form of latitude and longitude. However, many retail environments, such as a shopping mall, have plural retailers on different levels with similar latitudes and longitudes.

Thus, application 38 employs GPS as the primary method of identifying the retailer's location (to accurately reflect the retailer in the transaction process and endeavours to identify the retailer in the manner described above. If only one retailer is located in the area of the user (based on GPS location data), that retailer will be identified on display 28 for the user's confirmation. If the user indicates that the identified retailer is incorrect, or if application 38 locates plural retailers that match the GSP location data, application 38 displays the Select Retailer Group screen (as shown in FIG. 5) on display 28. The user selects the desired Retailer Group and a tick appears next to the chosen Retailer Group, in the illustrated example, the retailer group “7-Eleven” (trade mark).

FIG. 6 is a view of the Pay Retailer screen, which appears once the user has selected the retailer group. Application 38 uses the selected Retailer Group to distinguish between retailers at the location identified by the GPS location data, and prompts the user with this screen to confirm that specific retailer and location thus identified are correct. If the presented specific retailer is incorrect, the user can search for the correct retailer and location using a Retailer Smart Search Function. Otherwise, if the presented retailer is correct, the user enters the amount to be paid in an “Amount to Pay” field, using keypad 26. If the retailer has a plurality of POS terminals, the user is required to select the Terminal Number using a pull-down menu. The user is informed of the Terminal Number by the cashier at the time of the transaction, when the user requests that payment be made with system 10.

FIG. 7 is a view of the Payment Successful screen, which is displayed to the user when the payment information has been received by host server 12 and the confirmation and receipt successfully sent to POS terminal 16.

Within the Payment Successful screen, a receipt for the transaction is displayed identifying the amount transacted and its unique receipt number or code, as well as the retailer and terminal where the payment was made. At the bottom of the Payment Successful screen, there is also provision for displaying Customer Retention programs, to be displayed using a Customer Retention System (CRS) of system 10 (see below).

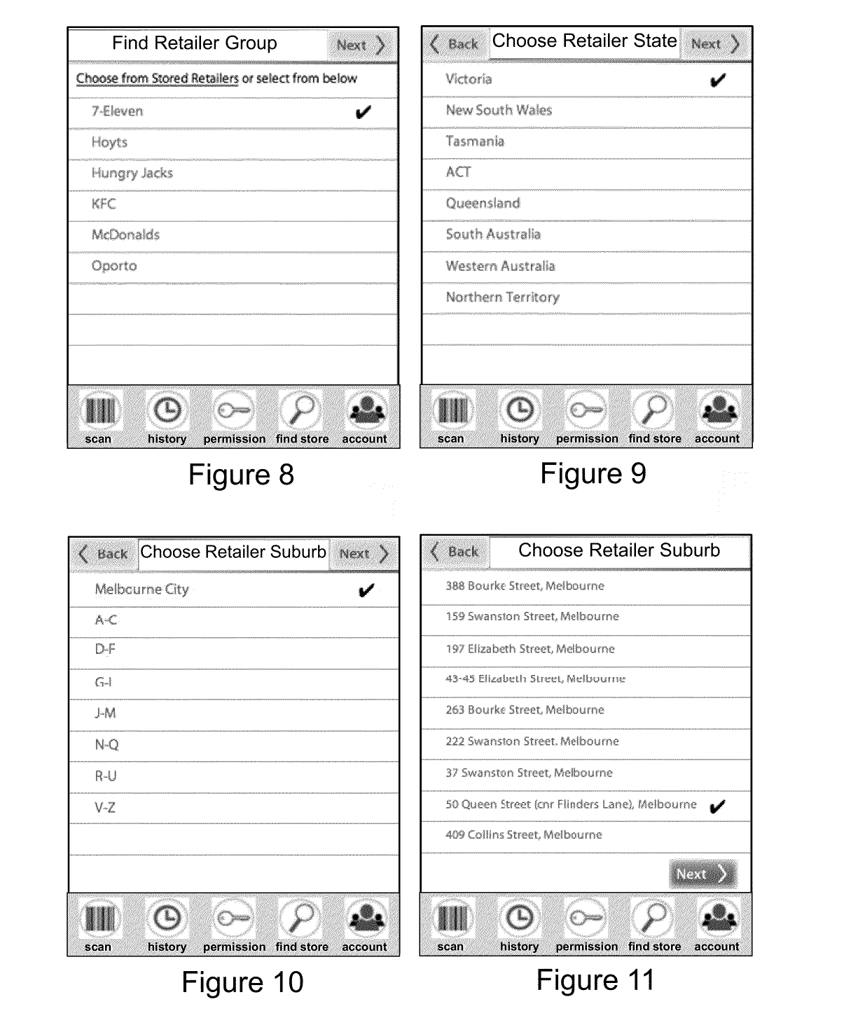

FIG. 8 is a view of the Find Retailer Group screen, which allows the user to user a Find Retailer process within application 38 and hence identify a retailer where one or more of the following are unavailable:
There is no GPS available on mobile telephone 18 (either permanently or temporarily);
A result for the retailer cannot be found or there is a conflict in the GPS location data arising from multiple retailers within an area that cannot be resolved by application 38;
The user is unable to scan the QR code of the retailer, typically displayed near POS terminal 16 to identify the retailer and terminal.

In these cases, the user can click on a “Find Store” icon at the bottom of any of the screens or on the “Click here to search” link in the Pay Retailer screen (see FIG. 6) to begin manually searching for a retailer.

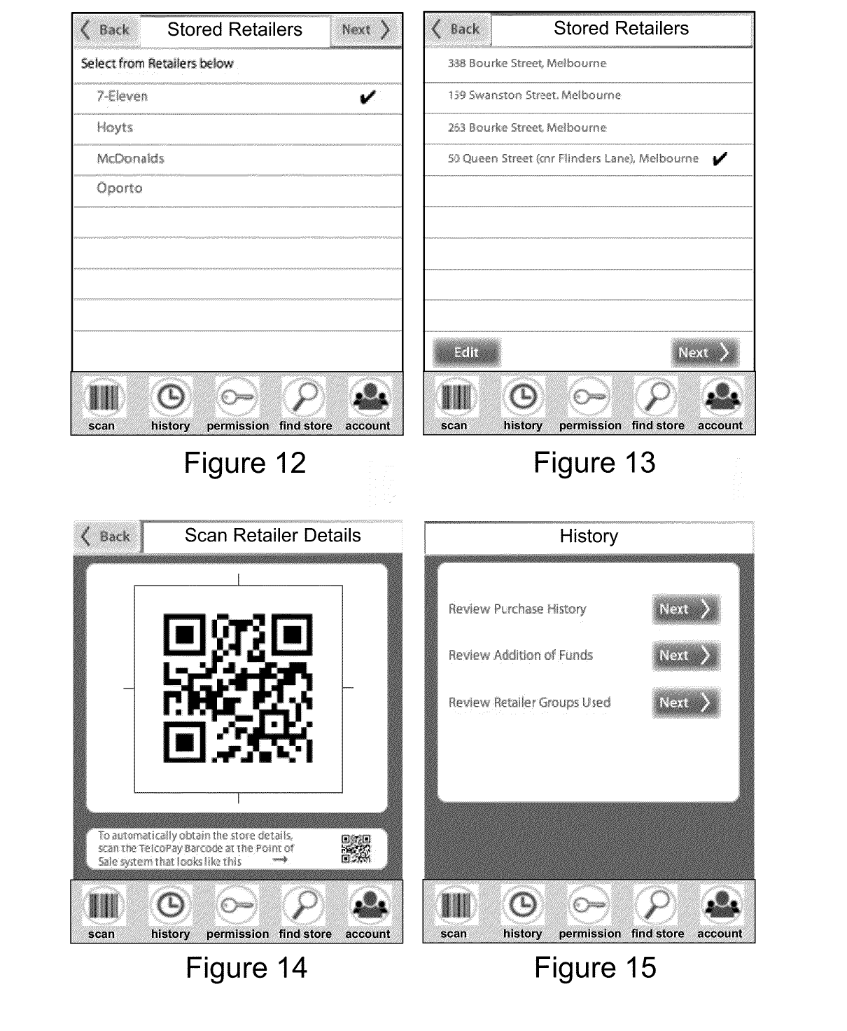

Within the Find Retailer Group screen of FIG. 8, the user can also click on a “Choose from Stored Retailers” link, which will take the user to the Stored Retailers screen (see FIGS. 12 and 13, and accompanying description below).

The Find Retailer Group, when selected, prompts application 38 to display an alphabetical list of all retailer group that accept payment using system 10. The user then selects the appropriate Retailer Group, just as when presented with the screen shown in FIG. 5. However, as the user's location is not known, application 38 then presents the user with the Choose Retailer State screen, shown in FIG. 9. The user selects the appropriate state, then application 38 presents the user with the Choose Retailer Suburb screen, shown in FIG. 10. The user selects the appropriate suburb (by selecting a range of letters of the alphabet into which the first letter of the suburb's name falls), to which application 38 responds by presenting the user with a further Choose Retailer Suburb screen, shown in FIG. 11, in which all the specific stores of the selected retailer group in the selected state and group of suburbs are listed. The user selects the specific retailer and selects “Next” to continue with a payment. In this scenario, the user would be brought back to the Pay Retailer screen (see FIG. 6).

By this series of steps, the user can quickly identify the correct store in which the transaction is to be conducted.

In order to make this process even quicker (at least in most cases), application 38 uses the stored home state, suburb and postcode of the user—which are collected when the user first registers to use system 10—as follows. It is assumed that most transactions are conducted within a particular distance (typically about 20 km) from a person's home or workplace. Application 38 thus prioritizes stores accordingly. Thus, in the Choose Retailer State screen, shown in FIG. 9, the home state of the user is placed at the top of the list of states. If the user does not select his or her home state, the process proceeds as described above, with each set of options presented in alphabetical order. If, however, the user selects his or her home state, application 38 assumes, in effect, that the user will be located within 20 km of the address provided by the user when registering to use system 10. Hence, application 38 then display the screen shown in FIG. 10, but with a specific suburb or district placed at the top of the list of options according to that home address.

Also, in some embodiments, memory 40 is provided with details of all the retailers and stores at which payments may be made suing system 10 and located within 20 km of the user's registered address. This list is maintained by application 38 based on data received from host server 12 and past transaction by the user. This list allows, for many users, a large proportion of their transactions to be conducted based on store data located on mobile telephone 18. If mobile data reception is slow, the amount of data that must be received by mobile telephone 18 is thereby greatly reduced.

FIG. 12 is a view of the Stored Retailers screen. By default, system 10 captures every retailer that a user has performed a transaction with using system 10 for future reference. A table of such retailers and their details are stored in memory 40 and maintained by application 38 so that transactions can be performed more quickly when the user makes a subsequent transaction with one of the stored retailers.

For example, the first time the user makes a payment with system 10 at 7-Eleven (trade mark) at 50 Queen Street, Melbourne, application 38 ascertains the GPS latitude and longitude co-ordinates of the store at the time of the actual transaction at POS terminal 16 as determined by application 38 (which may differ somewhat depending on the size of the store from other parties had determined where the correct latitude and longitude), and stores that location data with the retailer's identity in memory 40. These stored, more relevant GPS co-ordinates are thus available for use on the next visit to the same store by that user, so are used to more reliably identify the retailer thereafter.

FIG. 13 is a view of the Stored Retailers detailed screen. Once the user has selected the Retailer Group, the individual Retailer Group stores at which the user has previously performed a transaction is displayed by application 38.

The user can Select the Store, Edit the Details of the Store (pertaining to the user only) or View the Details of the Store (by activating a magnifier glass icon) to see where the store actually is and the attributes of the store (such as to see whether that store provides a particular good or service, such as Money Transfer services).

FIG. 14 is a view of the Scan Retailer Details screen, for scanning QR codes for store IDs. In the event that the user is not able to obtain the correct Retailer location details through the GPS coordinates from mobile telephone 18 (see FIG. 5 and accompanying description), or merely for greater convenience, the user can use a Scan function of application 38.

The Scan function requires the user to point the camera of mobile telephone 18 at a QR code provided as a part of system 10, which is mounted next to POS terminal 16. When the Scan function determines that a QR code is in view, then Scan function takes a picture of the QR code and matches it against QR codes stored in memory 40.

The user need thus only point the camera at the QR code (usually for one second or less) until application 38 registers the code; application 38 performs the balance of the function. If the QR code is valid, the user is taken directly to the Pay Retailer screen (see FIG. 6).

FIG. 15 is a view of the History screen, which provides the user with detailed History of the user's use of application 38. The user may select “Review Purchase History”, “Review Addition of Funds”, or “Review Retailer Groups Used”, to which application 38 responds by displaying the corresponding information, as described as follows.

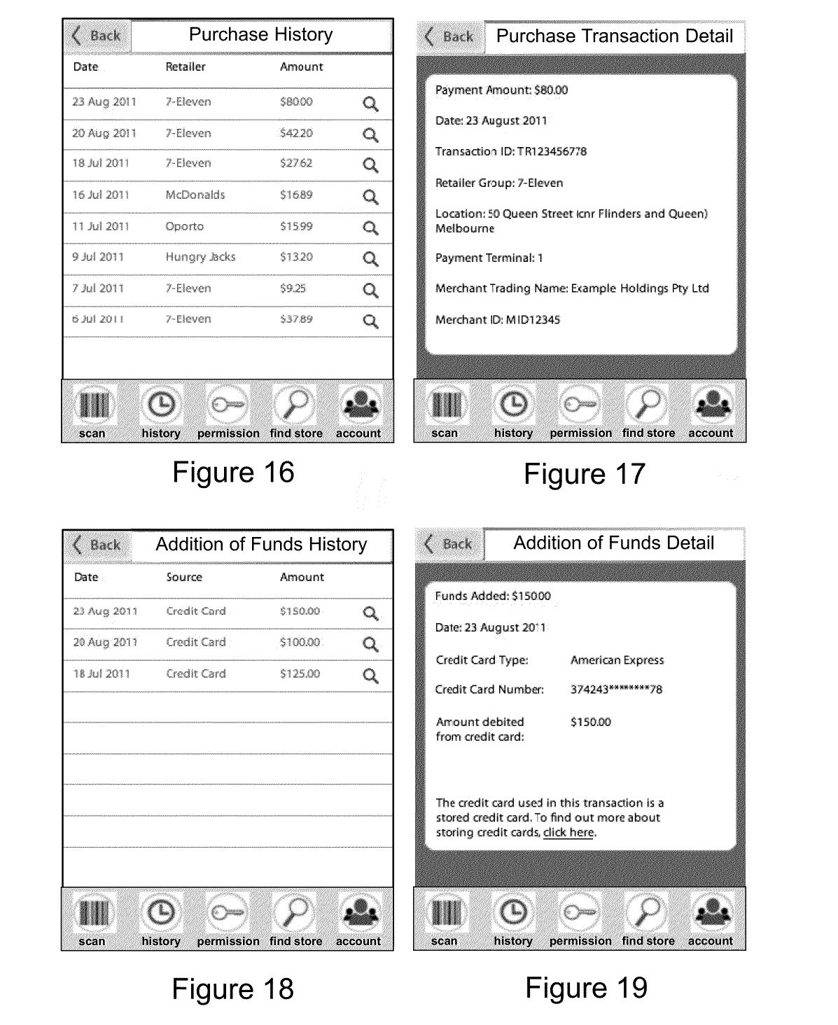

FIG. 16 is a view of the Purchase History screen, which identifies all of the payments that have been made by the user using application 38. A magnifying glass icon is provided for each transaction, to allow the user to drill down into the detail of the individual transaction. When the user activates a magnifying glass icon, the Purchase Transaction Detail screen is displayed for the selected transaction (an example of which is shown in FIG. 17). The Purchase Transaction Detail screen identifies all of the stored details in relation to a specific transaction, including:
Date of transaction
Transaction amount
Retailer Group
Retailer Location
Payment Terminal Used
Retailer Trading Name, and
Retailer ID number

FIG. 18 is a view of the Addition of Funds screen, which identifies all of the transactions that have occurred as a result of the addition of funds to eWallet 14 by the user using application 38. Again, clicking on a magnifying glass icon will drill down into the transaction detail, as illustrated in FIG. 19. FIG. 19 is a view of the Addition of Funds Detail screen, which identifies all of the detail in relation to an addition of funds transaction, including:
Date of transaction
Amount of Funds added
Credit Card Type
Credit Card Number
Amount debited from the card
Information as to whether the transaction came from a stored credit card transaction ore whether the transaction was a one off transaction.

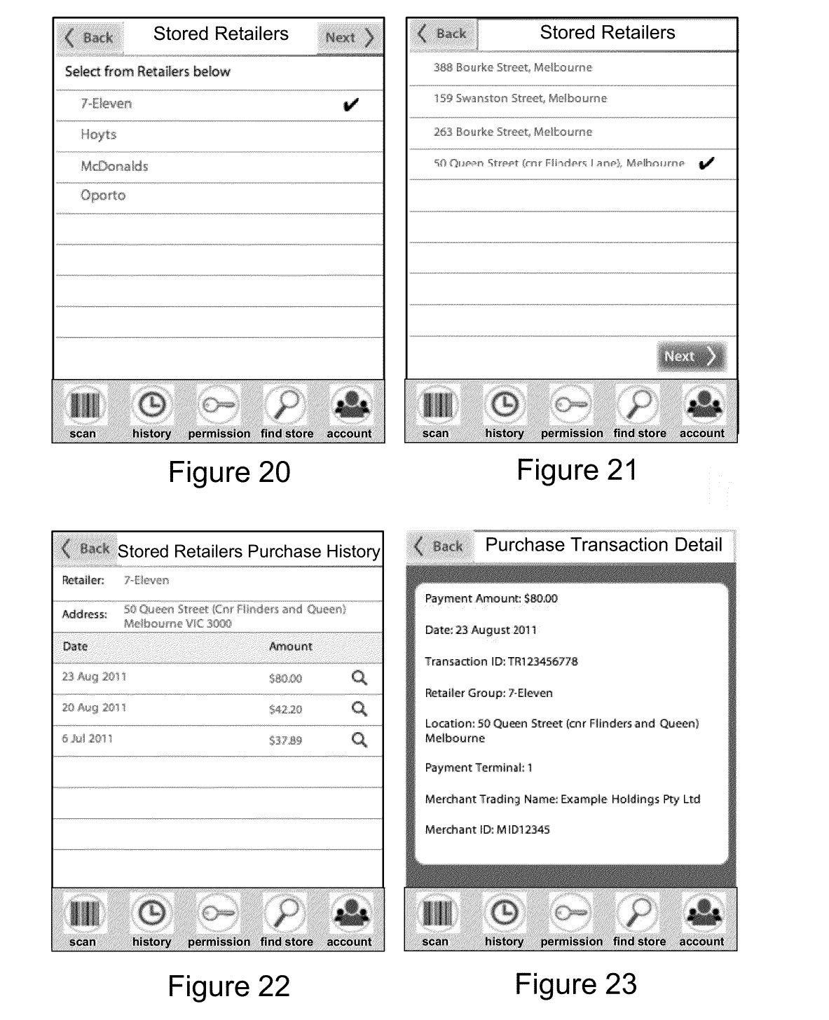

FIG. 20 is a view of the Stored Retailer Groups history screen; this section of History is similar to the Stored Retailer Groups (see FIG. 12), but is designed to allow searching and selection of retailers and stores from amongst those at which the user has previously conducted a transaction and listed as such in memory 40. Similarly, FIG. 21 is a view of the Stored Retailers details screen, which is similar to that of FIG. 11, but which allows the user to select the actual location of the Retailer from those at which the user has previously conducted a transaction. The user then selects “Next”, and application 38 responds by displaying (see FIG. 22) a Stored Retailers Purchase History screen. This screen presents past transactions at the selected store; the user can click on a magnifying glass icon to obtain a more detailed view of a past transaction at the selected store. Application responds by displaying a Stored Retailers Purchase Transaction Detail screen (see FIG. 23), which identifies to the user the same transactional information as shown in FIG. 17, that is:
Date of transaction
Transaction amount
Retailer Group
Retailer Location
Payment Terminal Used
Retailer Trading Name, and
Retailer ID number

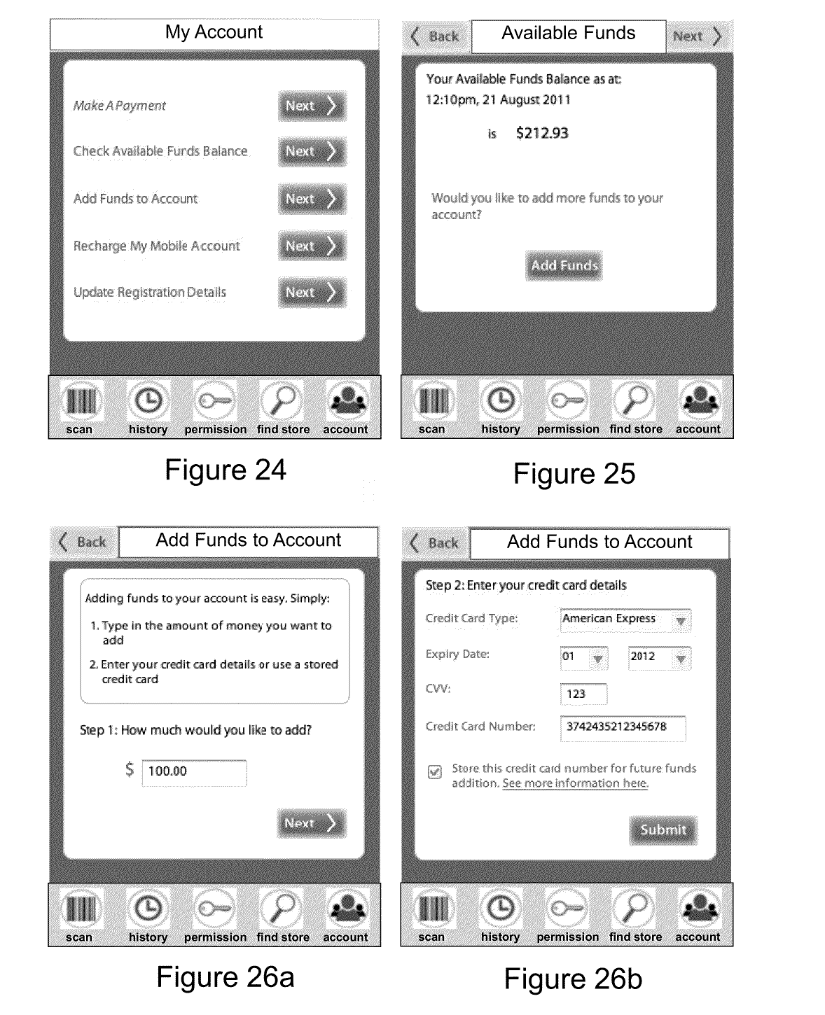

FIG. 24 is a view of the MyAccount screen, which allows a user to perform various administrative functions to maintain their account, including:
Make a Payment
Check Available Funds Balance
Add further funds to their account to ‘top up’ the balance of eWallet 14
Use user funds within system 10 or from an external source (such as a credit card) to recharge the balance of eWallet 14
Update user registration details

If the user selects “Make a Payment,” the user navigates directly to the payment screens described above, beginning with the Select Retailer Group screen (see FIG. 5), that a user would normally enter when launching application 38.

“Check Available Funds Balance” allows the user to determine the balance of his or her eWallet 14 and hence available for use with system 10. If the user selects this option, the Available Funds screen (see FIG. 25) is displayed. The Available Funds process also allows the user to Add Funds to his or her of eWallet 14 from an external source, as discussed below. The available funds are retrieved from host server 12 and not from application 38. Where access to host server 12 is unavailable, the Available Funds Balance displayed is the last known amount (i.e. to application 38) with a disclaimer that this is not a live or updated amount.

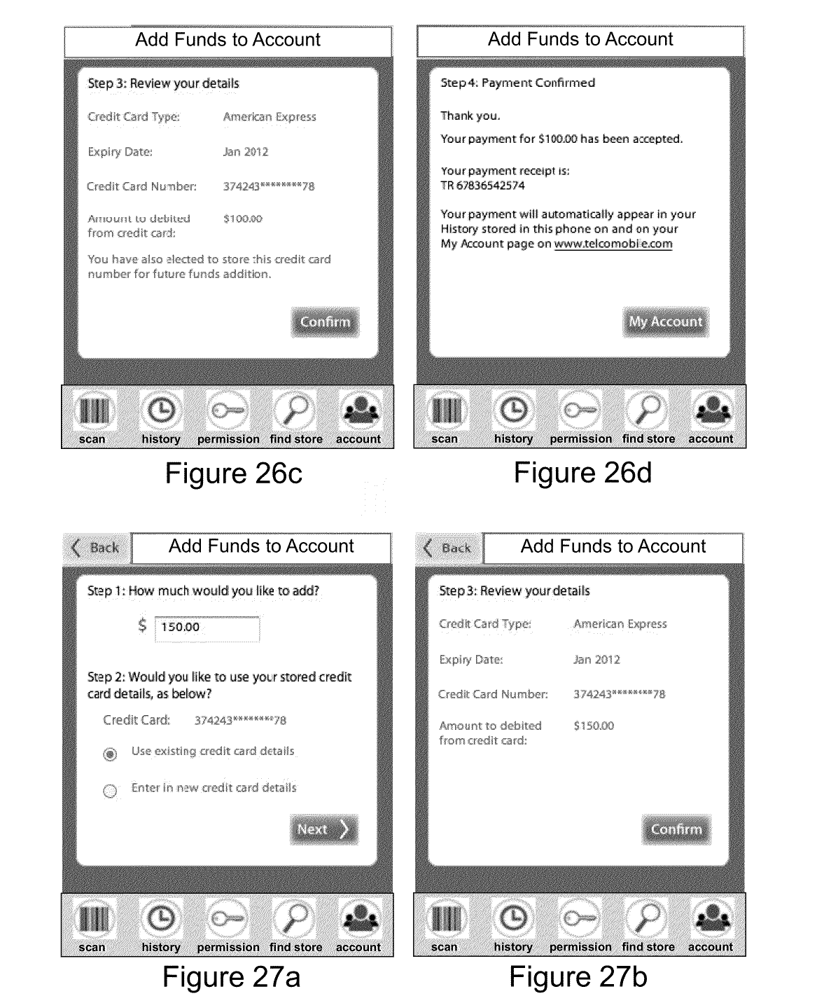

The “Add Funds to Account” function, when selected by the user, prompts application 38 to presented with the screen shown in FIGS. 26a to 26d. The screen shown in FIG. 26a prompts the user to enter how much the user would like to add to his or her account. Once the user enters the amount in either whole dollars or inclusive of the decimal point, the user selects “Next” and the screen of FIG. 26b is displayed. This screen prompts the user to enter a method of payment (e.g. credit card, debit card, PayPal (trade mark), payclick by Visa (trade mark), etc).

In the illustrated example, the user is performing a credit card transaction for the first time and does not have any credit card details stored with host server 12. The user enters his or her details and selects the check box to store if he or she wishes to save the credit card, etc, details for future payments. The user then selects the “Submit” button. At this point application 38 validates the credit card, including determining the stateless validity of the card being used; for example, application 38 assesses whether the card has the right number of digits, whether the expiry date appears valid and whether a CVV has been entered.

Once the “Submit” button has been pressed, the credit card details are transmitted securely to host server 12, and leave application 38. That is, a log is produced within application 38 of the transaction but the full credit card details of the user are masked. The process is thus PCI-DSS compliant.

If the validity checks have been passed, the user is required to review their details, as shown in FIG. 26c. As can be seen in this example, no credit card data is exposed (in accordance with PCI-DSS compliance regulations). If all of the details are correct, the user selects the “Confirm” button. This prompts application 38 to sent data indicative of the user's confirmation to host server 12 to trigger the transaction for payment processing and addition of funds to the user's account. Application 38 then displays a Payment Confirmed screen (see FIG. 26d).

The user can navigate back to the My Account screen (see FIG. 24) via the “Account” icon at the bottom of each screen or through the “Account” icon in the navigation bar.

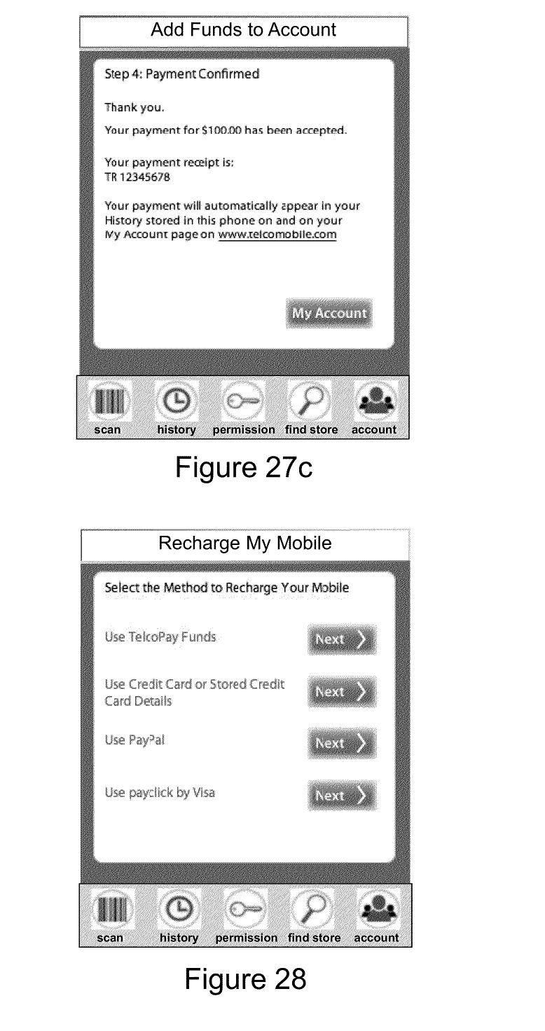

In another scenario, the user has previously store credit card details so the Add Funds to Account screen (cf. FIG. 26a) is modified to additionally ask whether the user wishes to use existing payment (e.g. credit card) details or enter new details (see FIG. 27a). If the user selects the latter option, application 38 display the screen of FIG. 26b and prompts for payment method. If the user selects the use of existing payment details, however, application 38 retrieves the one or more sets of stored credit card details and presents the masked PAN details of the stored credit card(s) to the user (see the “Review your details screen of FIG. 27b) for selection (if more than one set are stored) and in all cases to ensure that the correct details are going to be used; this screen also displays the payment amount entered into the screen of FIG. 27b.

If the user selects the “Confirm” button, the transaction is processed as described above and, if successful, a Confirmation screen (see FIG. 27c) is displayed.

This transaction can now be viewed in the History—Addition of Funds screens (see FIGS. 18 and 19).

FIG. 28 is a Recharge My Mobile screen, which allows the user to control application 38 to add mobile pre-paid credit (i.e. credit flagged specifically for telephone and/or data usage only) to the user's account, to recharge their mobile telephone from a number of sources, being:
Existing funds in eWallet 14
Credit card, via an ad hoc transaction
Credit card, via stored credit card, PayPal, payclick by Visa, etc.

To do so, the user selects a payment method and presses “Next”, which transfers processing to the relevant payment processing method, as described below.

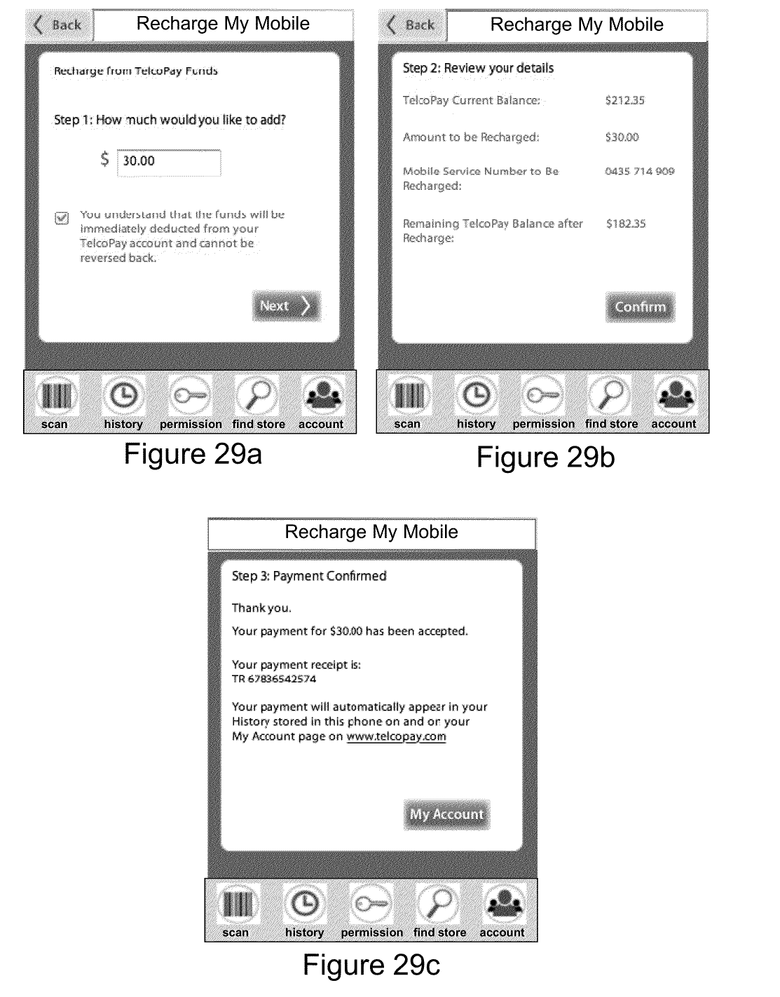

Thus, FIGS. 29a to 29c illustrate recharging using TelcoPay Funds (i.e. those of system 10). In the screen shown in FIG. 29a, the user must enter the amount of the Recharge to be performed; host server 12 then determines tariff rates through its integration with the a telecommunications service provider. The user must also acknowledge that, once transferred to perform a Mobile Recharge, the monies cannot be reversed back into their account. The user then presses “Next” to continue.

In the screen shown in FIG. 29b, the user is presented with a review of the processing of the transaction, including the current TelcoPay balance, the Amount to be Recharged, the Mobile Number being recharged and the TelcoPay account balance after a successful recharging. If the user presses the “Confirm” button, a live transaction occurs. If the user is not within network or Wi-Fi coverage, the user will be presented with an error message requesting they try again at a later time.

The Payment Confirmed screen shown in FIG. 29c is then displayed if the payment is successful; this screen includes a receipt number.

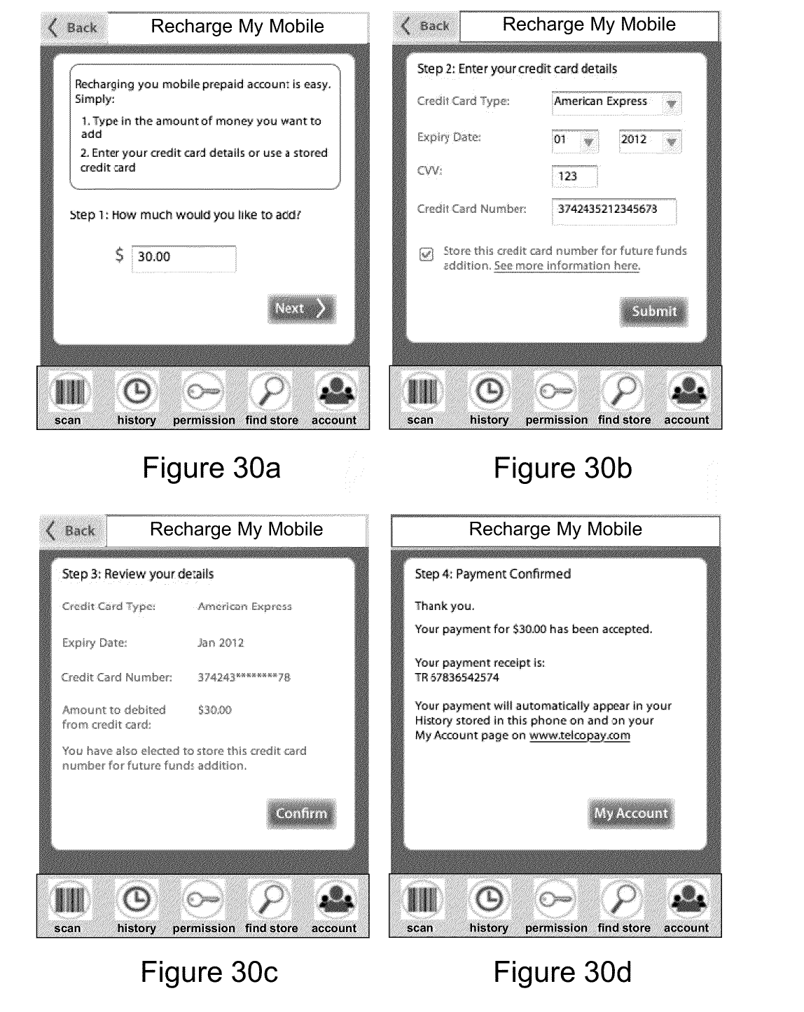

FIGS. 30a to 30d illustrate recharging using Credit Card Details. The Recharge My Mobile function using a credit card follows the same general procedure as the Addition of Funds using a credit card as illustrated in FIGS. 26a to 26d. The user starts the process by entering the amount of credit that they would like to add and presses “Next” (see FIG. 30a). An Enter Credit Card Details screen is this displayed (see FIG. 30b). In this example, the user is performing a credit card transaction for the first time and does not have any credit card details stored with host server 12. As can be seen in FIG. 30b, the option to store the credit card details to perform a quicker funds transfer in the future is provided.

Referring to FIG. 30b, the user enters his or her credit card details and selects the check box to store the credit card details for next transaction. The user then selects the “Submit” button. At this point the same validations described above are performed.

Once the “Submit” button has been pressed, the credit card details are transmitted securely to host server 12, and leave the application; again, logs produced within application 38 mask the credit card details of the user, and the process is PCI-DSS compliant.

The Review screen is then displayed (see FIG. 30c). This screen presents the transaction information for user review. If the user agrees with the details, the user selects the “Confirm” button and the transaction is processed.

The Payment Confirmed screen is then displayed (see FIG. 30d). This screen is displayed if the payment is successful.

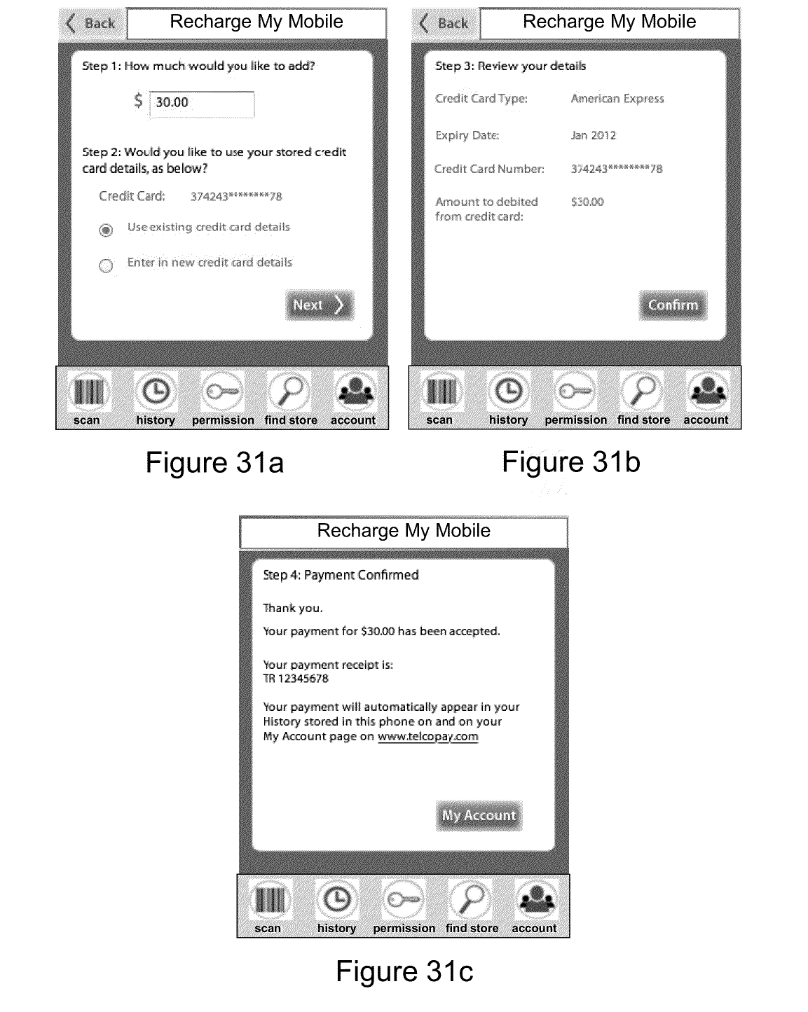

FIGS. 31a to 31c illustrate recharging using Credit Card Details, but with stored credit card details. In this scenario, which is generally similar to that illustrated in FIGS. 30a to 30d, the user has previously performed a successful credit card transaction and elected to store the details of the credit card employed in that transaction. Referring to FIG. 31a, the user enters the desired payment amount and application 38, which is aware of the stored credit card details (though they are stored on host server 12), presents the masked PAN details of the stored credit card to the user to ensure that the correct details are going to be used.

If the user elects to use of existing credit card details (which is also the default when details are stored), application 38 continues processing by displaying a confirmation screen (see FIG. 31b) and finally—if confirmation is received and the payment is successful—a “Payment confirmed” screen (see FIG. 31c), which includes a receipt number.

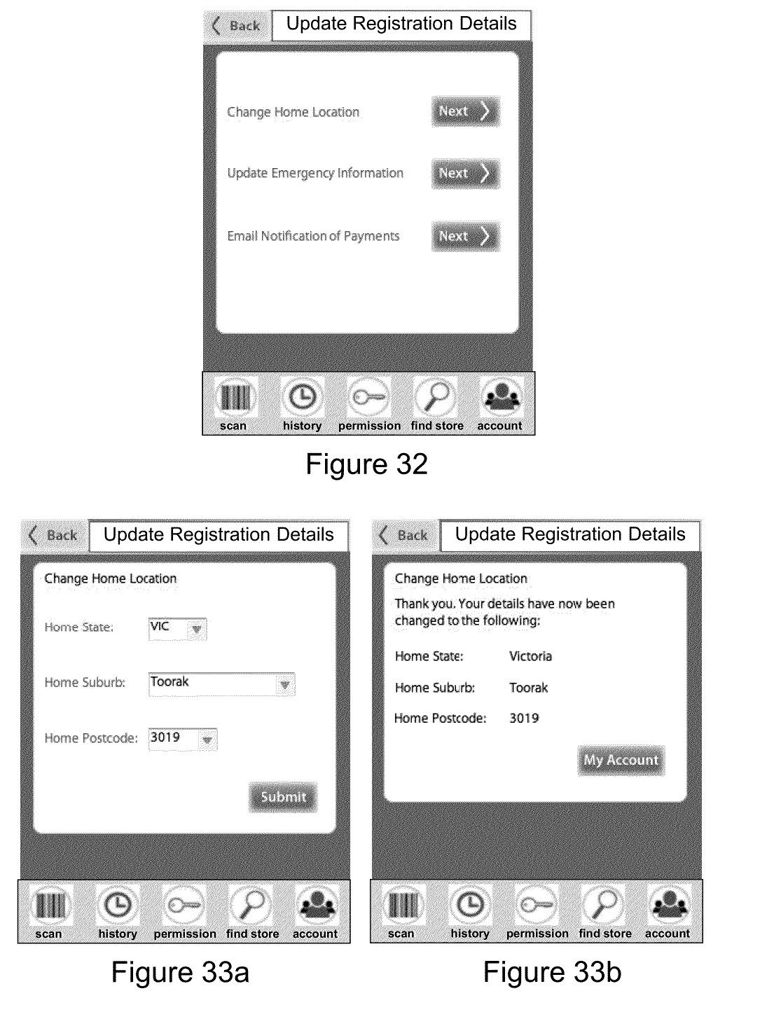

FIG. 32 shows the My Account “Update Registration Details” screen, which allows the user to:
Change Home Location
Update Emergency Information, and
Control email Notification of Payments.

Selecting the “Next” button next to the appropriate function takes the user to the relevant screens. Thus, FIGS. 33a and 33b illustrate “Change Home Location”. In screen shown in FIG. 33a allows the user to enter his or her home address down to the level of postcode/zipcode; more precise address details are not required. When the user selects the Home State, the Home Suburb List and the Home Postcode list automatically change to reflect the suburbs and postcodes available for that Home State.

Application 38 operates on the premise that the majority of transactions occur within 20 km of the user's home, which is facilitated by providing the user with an interface to maintain up-to-date home details.

Once the user has entered the Home Location details and selected the “Submit” button, the details are saved and the screen shown in FIG. 33b is displayed to confirm the details.

The user can go back to the My Account function by selecting the “Account” icon on the bottom of each screen or selecting the “Account” icon in the bottom navigation bar.

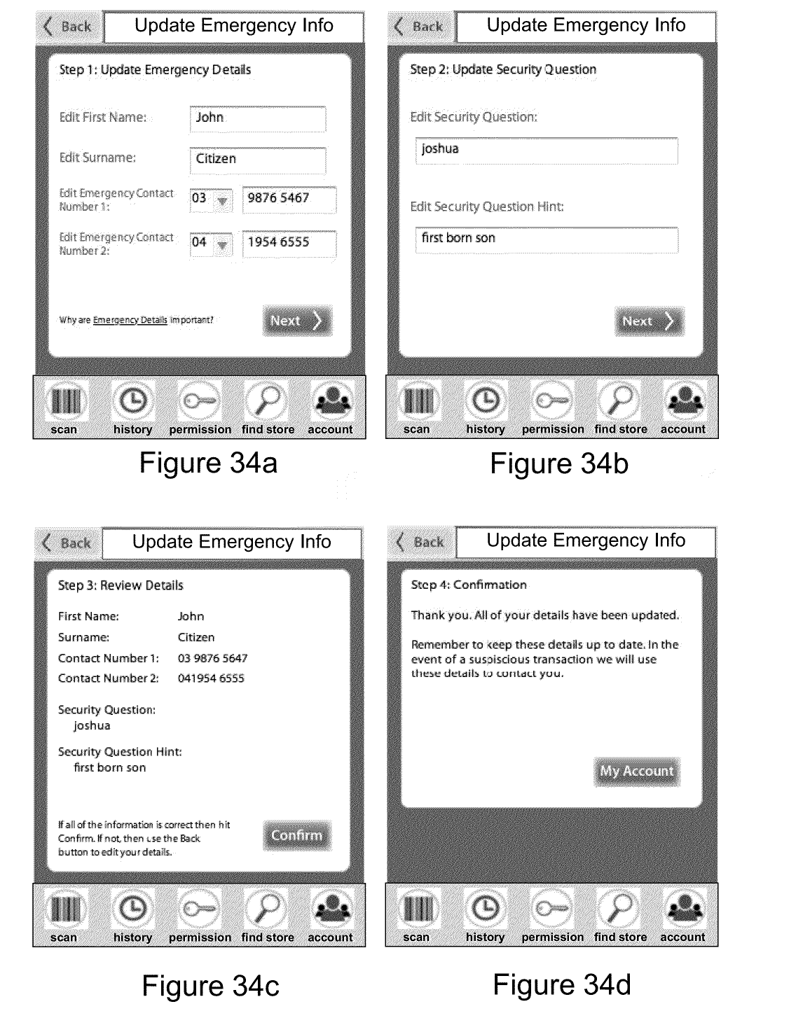

FIGS. 34a to 34d illustrate the Update Emergency Information screens. These screens are displayed by application 38 to allow the user to enter details of an emergency contact (FIG. 34a), provide a security question and answer (FIG. 34b), and review the emergency contact details and the security question and answer (FIG. 34c).

The user can hit the “Back” button (see FIGS. 34a and 34b) to review and amend any details, or hit the “Confirm” button (see FIG. 34c) to proceed. The screen of FIG. 34d is then displayed to provide confirmation that these details have been successfully updated.

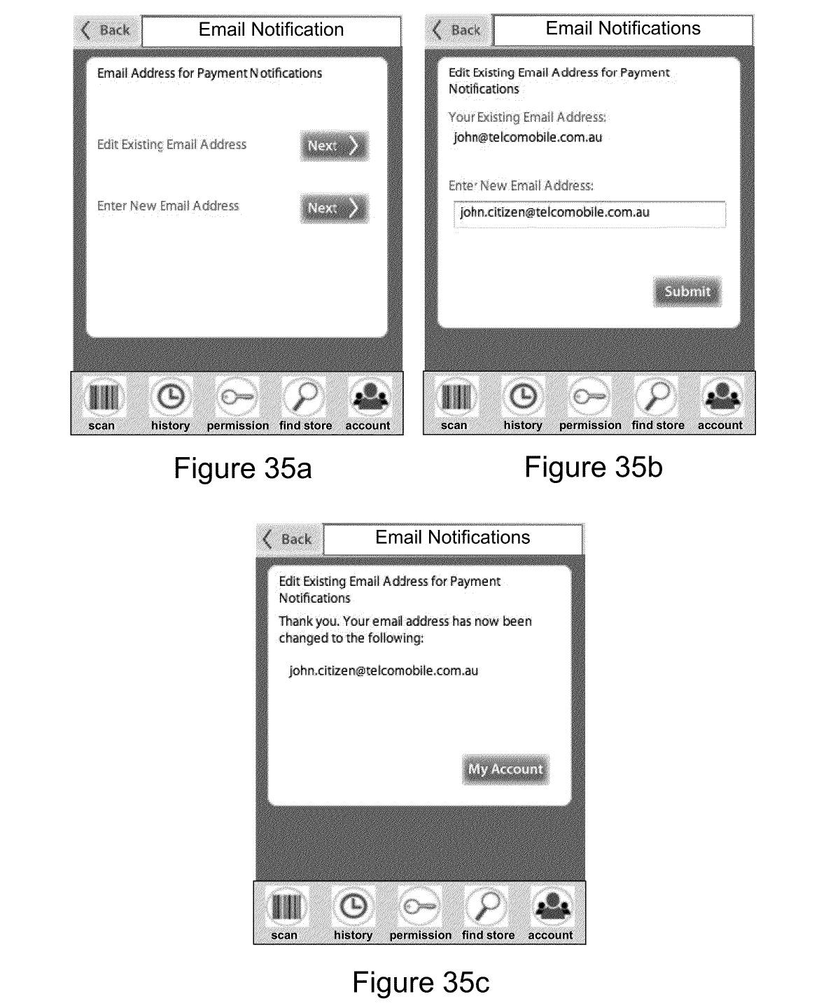

FIGS. 35a to 35d illustrate the Email Notification for Payments screens. Application 38 allows users to be notified by email whenever a payment is made to a vendor using application 38 or whenever an ancillary payment, such as the Addition of Funds or Recharge My Mobile function, occurs. The screen of FIG. 35a allows the user to enter a new email address or edit an existing email address to which such notifications should be sent. The screen shown in FIG. 35b shows the editing of an existing email address, while the screen shown in FIG. 35c presents confirmation of the edited address. On the next occasion that application 38 connects to host server 12 to perform a payment transaction, the edited (or new) email address is provided to host server 12, ensuring that connectivity to host server 12 is minimized.

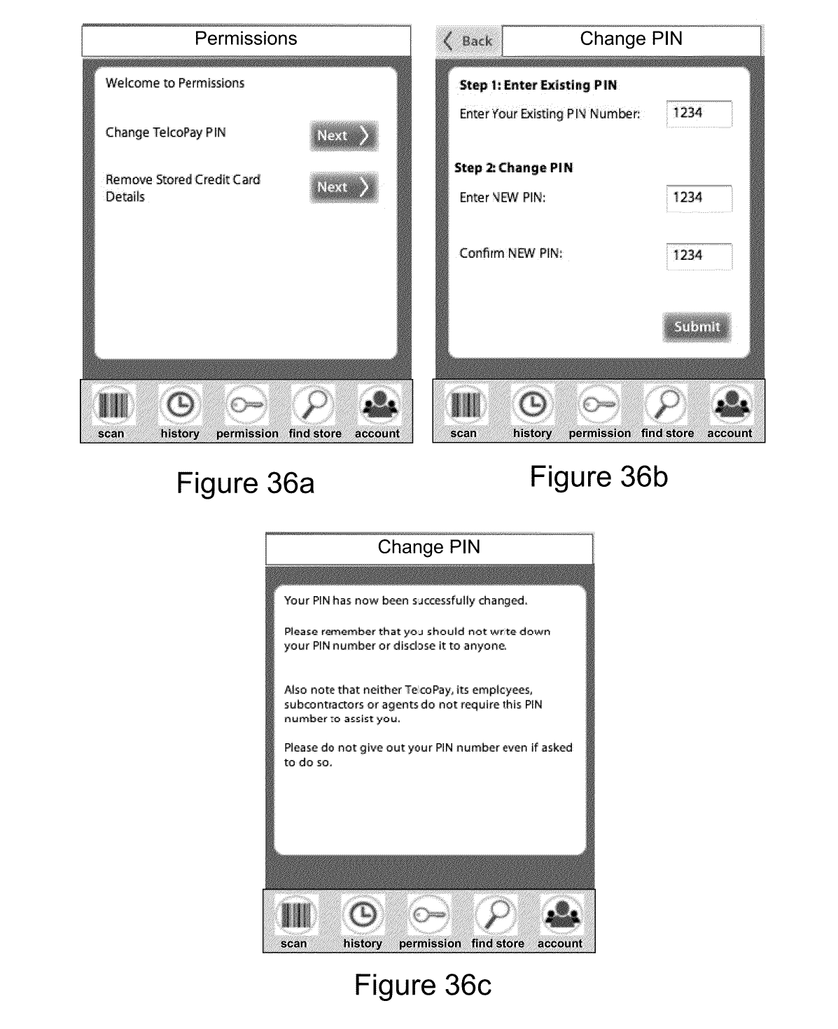

FIGS. 36a to 36c illustrate the Permissions interface screens; this interface allows the user to change application attributes stored within mobile telephone 18. There attributes are the PIN that secures application 38 (which can be changed) and stored credit card details (which can be removed).

Should the user wish to change the PIN, the use selects that option from the screen of FIG. 36a and the screen of FIG. 36b is displayed. This screen prompts the user for the existing PIN, a new PIN, and confirmation of the new PIN. The screen shown in FIG. 36c is then displayed to confirm that the PIN has been updated. Once the PIN has been changed, the user is given only five attempts to enter application 38 (see FIG. 4) with the new PIN before application 38 locks itself completely. Application 38 can only be re-used by uninstalling its current version and reinstalling a new version of application 38 on mobile telephone 18.

If, in the screen of FIG. 36a, the user selects “Remove Stored Credit Card Details,” those details are deleted and their deletion is confirmed. It should be noted that application 38 does not hold any exposed credit card details but rather, uses a process of storing tokens that used in lieu of credit card details and stored on host server 12. Those tokens are then securely used with the relevant credit card payment gateway to perform a transaction.

The following table provides information the data that is entered by the user and stored by host server 12.

| Data | | Data Presented | |
|---|---|---|---|
| Requested | Input Form | Back to User | Example |
| Credit Card | 15 or 15 digits, | Masked PAN | 345612********34 |
| Number | depending on | | (first 6 digits |
| | card program | | and last 2 digits) |
| | | | for all card types |
| Expiry Date | MM/YYYY | Expiry Date | MM/YY |
| | format | | |
| CVV | 3 or 4 digits | No information is provided by to | |
| | depending on | user in either confirmation or | |
| | card program | Stored Credit Card token processing | |
| Name on Card | Not Required | Not Required | Not Required |
| Store Credit | Checkbox | Radio button | See FIG. 30b, for |
| Card | selection | selection. | example |
| | | Default | |
| | | position is | |
| | | ‘On’ or ‘True’ | |

This function for removal of stored credit card details thus removes the encrypted and masked PAN data from application 38 and also sends a corresponding record to host server 12 to delete the token that had been associated with that masked PAN.

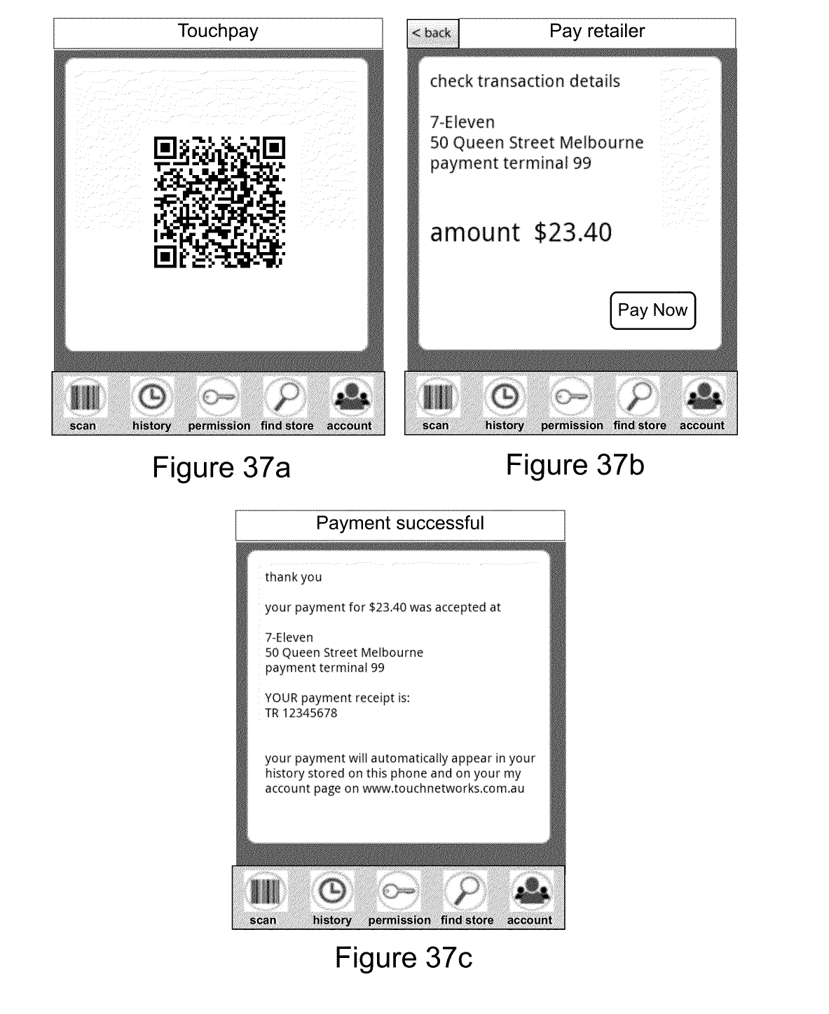

FIGS. 37a to 37c illustrate the screens displayed by system 10 when the user makes a payment using a simplified process in which POS terminal 16 communicates with mobile telephone 18 by means of a QR code. The merchant enters the details of the intended purchase into POS terminal 16 in the usual way, and POS terminal 16 then generates and displays a QR code with full details of the store identity and location, intended purchase and price (see FIG. 37a). This is scanned by the user with the camera of mobile telephone 18. Application 38 then has all the information required to associate the purchase with the user, so application 38 generates and displays a “Pay Retailer” screen (see FIG. 37b) containing the details of the proposed transaction, for user approval. This screen invites the user to confirm that the payment should proceed, which is done by the user selecting a “Pay Now” button. The transaction is then processed as described above and, if successful, application 38 generates and displays a “Payment Successful” screen (see FIG. 37c) including a receipt number.

System 10 also provides a scheduled regular purchase function (e.g. a pre-paid mobile telephone re-charge). This allows users to establish a regular purchase schedule of their account by a stipulated amount. Briefly, the user establishes this by:
Validating the user's identity;
Storing user credit (or debit) card details;
Selecting a product or service and its cost;
Selecting a frequency with which to create the recurring charge.

For example, the user can log into system 10 with a web browser, with username and password, select a $30 option pre-paid mobile re-charge option, select the regularity (such as “each calendar month”) and input credit card details. Every calendar month, the user will then be charged $30 for the service until either the credit card expires or the user stops the service.

System 10 also provides a similar “Subscription Auto-Recharge” function, in which the user can establish, for example, a scheduled auto-recharge using an (initially) unvalidated process:
the user accesses public website and logs onto system 10;
the user enters the mobile telephone number to be recharged;
the user passes through a recaptcha challenge;
the user selects recharge amount;
the user enters credit card details;
the user selects auto recharge and selects frequency
the user enters email address (twice);
the user confirms transaction; and
the transaction is processed.

If the transaction is successful, the user is then notified on screen that the auto-recharge was successful. A credit card token is established between our system and the credit card processor for future use of the credit card details in transactions.

After the successful transaction, an email is sent to the user to the email address provided during the transaction. The email describes the Auto-Recharge process and the attributes that were selected (for example, $30 every month). The user is then required to click on a “Subscribe” link within a predefined period of the email being issued (say 48 hours). If the user does not the “Subscribe” link, the Auto-Recharge process is not completed and is removed from system 10.

Once the user clicks on the “Subscribe” link, the user is redirected to a webpage that contains a specific encrypted path for the acceptance of the Auto-Recharge. The user, at this point, must hit a “Confirm” button to confirm the process. Unless the “Confirm” button is pressed, the Auto-Recharge does not begin.

After the user hits “Confirm”, a confirmation email is issued to the user, advising of the Auto-Recharge attributes and the details of the first Auto-Recharge transaction.

At a prescribed time (e.g. 48 hours) before a scheduled Auto-Recharge payment is to occur, system 10 sends the user an email advising of the payment to be taken from their card. If the user does nothing, payment is processed. If the user (up to a prescribed time before the transaction occurs) clicks on the “Unsubscribe” link in the email, system 10 halts the process and deletes it. The user will be taken to a web page where they will be presented with the details of the Auto-Recharge and requested to confirm the “Unsubscribe”. The user must then perform another Recharge transaction and set up another Auto-Recharge, if desired.

After a successful Auto-Recharge transaction, system 10 sends the user an Invoice email (which also includes an “Unsubscribe” link).

System 10 also has a Customer Retention System that can be integrated into application 38. This system offers several programs, include:
a “Buy n Get 1 Free” engine, which is a general reward loyalty scheme;
Buy Some, Get 1 Free;
Buy None, Get 1 Free: Distributing vouchers or codes that may be used, once only, to redeem a free prize. Vouchers/codes may be distributed by email, by SMS or as vouchers won from another Touch Loyalty scheme.
May also be used as a simple pool of unique account numbers or codes to be redeemed elsewhere, such as to claim a prize by mail. This is known as a dormant scheme.

Features:
Accounts may be pre-existing or they may be created upon redemption.
Accounts (or batches of accounts) can have individual expiry dates. Alternatively, accounts may never expire but be valid for as long as the promotion runs.
The initial points value can be 1 (immediate win) or greater.
Accounts may expire upon completion; or they may automatically reset to a non-zero points value, so that they may be used again. The reset points value can be different from the initial points value.
Different vouchers may be printed for each points value as it approaches zero.
Normally one point is earned each time; but the option exists to specify the number of points earned in the Touch transaction.

### Pro Rata Discount

The ‘Pro Rata Discount’ engine calculates a discount as either:
a percentage of (dollar) value, or
number of cents per unit (e.g. extra tariff per dollar recharged)

Ultimately these discounts are similar. Both are merely a number of cents per thing, where thing is a measure of value (dollars) or quantity (air time tariff, etc.)

To ensure that users qualify for a discount once and once only, requests includes an (loyalty) account number that cannot have been used before. Requests will also contain the value or quantity of goods sold upon which a discount is to be calculated. Requests may also contain an expiry date and/or the rate of the discount to be applied.

All, or part, of this information may be encapsulated in a barcode from a physical product such as a SIM pack.

### Applications

Cents per Dollar recharged for purchasing a new handset.
Free Air Time tariff on the existing user number or can be redeemed for another product (such as mobile broadband or SMS credit).

### Features

Accounts may be pre-existing or they may be created upon redemption.
Accounts (or batches of accounts) can have individual expiry dates. Alternatively, accounts may never expire but be valid for as long as the promotion runs.
Quantity (or value) of goods is specified in each request. Quantity may be expressed in whole numbers or fractional units; or dollars and cents. The quantity (or value) may be encapsulated in the barcode.
The Discount Rate (cents per unit) may be fixed for the whole scheme, or it may be specified in the redemption request. If the latter, it may be encapsulated in the barcode.
A voucher expiry date may be specified in the redemption request. A voucher expiry date may also be encapsulated in the barcode of a physical product such as a SIM pack.
The scheme may specify a minimum and maximum quantity. If quantity is below the minimum, no discount is earned. If quantity above the maximum, the discount is calculated using that maximum.
The discount is returned to the point of sale as an extra line item with a negative price.

### Random Reward

The ‘Random Reward’ engine is designed to randomly generate vouchers that entitle the user to a freebie, prize or discount on other goods and services. The prize voucher may be redeemable via Touch, perhaps as a part of a ‘Buy n Get 1 Free’ scheme, or in some other way. For example, the user may need to mail the voucher in to claim their prize.

### Applications

Issuing a prize voucher randomly from a pool of possible prizes on each transaction.

### Features

‘Random Reward’ schemes do not have accounts of their own. These schemes generate prize vouchers that may bear the account number of an account in another scheme, by which the user can claim their reward.
No theoretical limit on the number of different prizes that may be supported in the Random Reward process.
Voucher design may be totally different for each different prize.
Prizes may be linked to other schemes (such as ‘Buy n Get 1 Free’ or ‘Pro Rata Discount’), or may be simply an un-numbered voucher that is redeemed in some other way—not involving a Touch transaction.
A ‘Random Reward’ scheme may be made the target of a ‘Sequential Reward’ scheme to provide a random prize on a non-random basis, e.g. Every tenth transaction wins a prize, but that prize is randomly selected from a pool of possible prizes.

### Sequential Reward

The ‘Sequential Reward’ engine is much like a ‘Random Reward’. It, too, is designed to generate vouchers that entitle the user to a free prize or discount on other goods and services. The difference is that it does not do so randomly.

‘Sequential Reward’ works as follows: For each type of prize (freebie, discount, etc.), a separate prize scheme is created with a number of accounts in proportion to their rate of distribution and sufficient to meet the expected life of the scheme. Each scheme has a divisor associated with it, equal to the frequency with which a prize is to be won. For example, if a prize is to be won every 500th transaction, then the divisor is 500.

As each ‘prize claim’ transaction is processed, a transaction counter is incremented. For each prize scheme, the divisor is divided into the transaction counter and if the remainder equals that prize scheme modulus (which defaults to zero), then that prize is awarded.

### Applications

Issuing a prize voucher (or vouchers) once every N transactions.

### Features

‘Sequential Reward’ schemes do not have accounts of their own. They generate prize vouchers that may bear the account number of an account in another scheme, by which the user can claim their reward.
No theoretical limit on the number of different prizes that may be supported.
Voucher design may be totally different for each different prize.
Prizes may be linked to other schemes (such as ‘Buy n Get 1 Free’ or ‘Pro Rata Discount’), or may be simply an un-numbered voucher that is redeemed in some other way—not involving a Touch transaction.
Optionally, each scheme may also have a modulus setting associated with it that controls when the prize is first awarded. The modulus defaults to zero, so that if the divisor is 500, the prize first is awarded on the 500th transaction; the second on the 1000th transaction, etc. If the modulus is 123, the prize is first awarded on the 123rd transaction; the second on the 623rd transaction, and the third on the 1123rd.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in any country.

The claims defining the invention are as follows:

1. A payment system, comprising:
a host server;
a digital wallet for storing credit of a user;
a user mobile communications device for data communication with the host server; and
a point-of-sale terminal operable by a vendor;
wherein the point-of-sale terminal is configured to receive purchase data indicative of a desired purchase by the user and to transmit the purchase data to the host server, the purchase data including price data, the mobile communications device is configured to receive the purchase data from the host server or from the point-of-sale terminal and to prompt the user to input user authorization, the mobile communications device is configured to receive the user authorization and in response thereto to transmit authorization data to the host server, and the host server is configured to respond to receiving the authorization data by initiating transfer of funds according to the price data from the digital wallet to a vendor account.

2. A system as claimed in claim 1, wherein the host server includes a database of vendors and respective vendor locations.

3. A system as claimed in claim 2, wherein the mobile communications device is configured to search the database of vendors and respective vendor locations.

4. A system as claimed in claim 1, wherein the host server includes a user address database containing an address of the user.

5. A system as claimed in claim 2, wherein the host server includes a user address database containing an address of the user, the host server is configured to search the database of vendors and respective vendor locations for all vendors within a predefined distance of the address of the user, and to download to the mobile communications device identification data indicative of the vendors within the predefined distance of the address of the user, and wherein the mobile communications device is configured to store the identification data thus downloaded in a searchable memory of the mobile communications device.

6. A system as claimed in claim 5, wherein the predefined distance is between 10 and 30 kilometres.

7. A system as claimed in claim 5, wherein the predefined distance is between 15 and 25 kilometres.

8. A system as claimed in claim 5, wherein the predefined distance is approximately 20 kilometres.

9. A payment method, comprising:
a point-of-sale terminal receiving purchase data indicative of a desired purchase by a user, the purchase data including price data;
the point-of-sale terminal transmitting the purchase data to a host server;
a user mobile communications device receiving the purchase data from the host server or from the point-of-sale terminal;
the mobile communications device prompting the user to input user authorization;
the mobile communications device receiving the user authorization and in response thereto transmitting authorization data to the host server; and
the host server responding to receiving the authorization data by initiating transfer of funds according to the price data from a digital wallet of the user to a vendor account.

10. Computer software executable on a computing system that, when executed, implements the payment method of claim 9.
